(19) United States
(12) Patent Application Publication
(10) Pub. No.: US 2025/0007329 A1
(43) Pub. Date: Jan. 2, 2025

(54) WIRELESS CHARGING TRANSCEIVER DEVICE AND SYSTEM CAPABLE OF ADJUSTING RESONANT FREQUENCY

(71) Applicants: ELECTRONICS AND TELECOMMUNICATIONS RESEARCH INSTITUTE, Daejeon (KR); INCHEON NATIONAL UNIVERSITY RESEARCH & BUSINESS FOUNDATION, Incheon (KR)

(72) Inventors: Seong Min KIM, Daejeon (KR); Saidul Alam Chowdhury, Incheon (KR); Duk Ju Ahn, Incheon (KR)

(21) Appl. No.: 18/756,613

(22) Filed: Jun. 27, 2024

(30) Foreign Application Priority Data
Jun. 29, 2023 (KR) 10-2023-0084535
Aug. 17, 2023 (KR) 10-2023-0107523

(51) Int. Cl. H02J 50/12

(52) U.S. Cl. CPC H02J 50/12

(57) ABSTRACT

A wireless charging reception system and control method capable of adjusting resonance frequency are disclosed. According to an embodiment of the present disclosure, a wireless charging reception system capable of adjusting the resonance frequency may include a resonance circuit unit including a circuit in which a resonance inductor and a resonance capacitor are connected in parallel; a transmission circuit unit including a transmission inductor and a power supply voltage unit adjacent to the resonance inductor within a threshold distance; a switch unit connected in parallel with the resonance circuit unit and including at least one switch; a rectifier circuit connected in parallel with the switch unit and the resonance circuit unit; and a control unit that controls a phase of transmission current flowing through the transmission inductor generated through the power voltage unit to be same as a phase of current associated with the at least one switch.

### CROSS-REFERENCE TO RELATED APPLICATIONS

This application claims the benefit of earlier filing date and right of priority to Korean Application No. 10-2023-0084535, filed on Jun. 29, 2023 and Korean Application No. 10-2023-0107523, filed on Aug. 17, 2023, the contents of which are all hereby incorporated by reference herein in their entirety.

### TECHNICAL FIELD

The present disclosure relates to the field of wireless charging technology, and more specifically, to a wireless charging transmission and reception device and system that adjusts the resonant frequency of a receiving coil to obtain maximum efficiency in a changing transmission environment in a wireless charging receiver.

### BACKGROUND

Methods for adjusting the resonance frequency of the receiving coil are continuously being developed and utilized in order to obtain and maintain optimal charging efficiency in response to changing transmission environments in wireless charging devices.

In particular, in the case of the series resonance method in which a resonance circuit is formed by connecting a capacitor in series with the receiving coil for resonance of the receiving coil, a structure for adjusting the resonance frequency using a capacitor for setting the basic resonance frequency and a switch connected in parallel to it has been proposed.

Previously, a method of adjusting the resonant frequency by adjusting the phase of the charging circuit was proposed by connecting a separate switch for adjusting the resonant frequency of the receiver. However, the above-described charging circuit configuration has the problem of not only increasing the complexity of implementation but also increasing the difficulty of control.

In addition, since the above-described charging circuit is configured to add a capacitor using switches connected in parallel, there is a problem that the charging circuit can only be controlled in the direction in which the total capacitor value increases.

### SUMMARY

The technical problem of this disclosure relates to a wireless charging transmission and system that can control resonant frequency control in parallel resonant receiver.

The technical problem of the present disclosure relates to a device and system for adjusting the resonance frequency by adjusting the phase of the rectifier.

The technical problems to be achieved in the present disclosure are not limited to the technical tasks mentioned above, and other technical problems not mentioned will be clearly understood by those skilled in the art from the description below.

A wireless charging reception system and control method capable of adjusting resonance frequency are disclosed. According to an embodiment of the present disclosure, a wireless charging reception system capable of adjusting the resonance frequency may include a resonance circuit unit including a circuit in which a resonance inductor and a resonance capacitor are connected in parallel; a transmission circuit unit including a transmission inductor and a power supply voltage unit adjacent to the resonance inductor within a threshold distance; a switch unit connected in parallel with the resonance circuit unit and including at least one switch; a rectifier circuit connected in parallel with the switch unit and the resonance circuit unit; and a control unit that controls a phase of transmission current flowing through the transmission inductor generated through the power voltage unit to be same as a phase of current associated with the at least one switch.

In addition, the current associated with the at least one switch may include current flowing in a gate of the at least one switch for driving the at least one switch.

In addition, the rectifier circuit unit may include at least one diode or at least one inductor connected in parallel to each of the resonance circuit unit and the switch unit.

In addition, the control unit may include a detection circuit for detecting the phase of the transmission current and a control circuit for controlling the phase of the current flowing through the gate of the at least one switch, and the rectifier circuit may be connected in series with at least one of a load to which an output voltage is to be applied or an additional inductor.

In addition, based on the phase of the transmission current being detected through the detection circuit, the control unit may control the control circuit so that a phase of the detected transmission current and the phase of the current of the gate of the at least one switch are a same value.

In addition, the detection circuit may include a sensing inductor and a transformer for detecting the phase of the transmission current, and one of two inductors constituting the transformer may be connected in series with the resonance inductor in the resonance circuit unit.

In addition, the control unit may control a mutual inductance value between the sensing inductor and the resonance inductor so that a mutual inductance value of the transformer is a same value.

According to another embodiment of the present disclosure, a method of controlling a wireless charging reception system with adjustable resonance frequency may include generating a current flowing in a transmission inductor by driving a power supply voltage unit included in a transmission circuit unit; detecting a phase of current flowing in the transmission inductor; and controlling a phase of the detected current flowing in the transmission inductor and a phase of current associated with at least one switch included in a switch unit to a same value, and the switch unit may be connected in parallel with a resonance circuit unit including a resonance inductor and a resonance capacitor adjacent to the transmission inductor within a critical distance, and a current circuit unit may be connected in parallel to the switch unit and the resonance circuit unit.

In addition, the system may include a detection circuit for detecting the phase of the transmission current and a control circuit for controlling the phase of the current flowing in the gate of the at least one switch, and

According to another embodiment of the present disclosure, a wireless charging reception device capable of adjusting a resonance frequency may include a resonance circuit unit including a circuit in which a resonance inductor and a resonance capacitor are connected in parallel; a switch unit connected in parallel with the resonance circuit unit and including at least one switch; a rectifier circuit connected in parallel with the switch unit and the resonance circuit unit; and a control unit that controls a phase of transmission current flowing in a transmission inductor and a phase of current associated with the at least one switch to be a same value, based on the transmission inductor of a wireless power transmission device being adjacent to the resonance inductor by a threshold distance.

The features briefly summarized above with respect to the disclosure are merely exemplary aspects of the detailed description of the disclosure that follows, and do not limit the scope of the disclosure.

According to various embodiments of the present disclosure, a wireless charging receiver device and system capable of adjusting the resonance frequency in a parallel resonance receiver may be provided.

According to various embodiments of the present disclosure, devices and systems for adjusting the resonant frequency by adjusting the phase of a rectifier may be provided.

According to various embodiments of the present disclosure, when the inductor-capacitor resonance frequency is higher than the feeding frequency (or when the capacitance is insufficient), the discrepancy between the resonant frequency and the feeding frequency may be resolved and automatically matched.

The effects obtainable in the present disclosure are not limited to the effects mentioned above, and other effects not mentioned will be clearly understood by those skilled in the art from the description below.

### BRIEF DESCRIPTION OF THE DRAWINGS

The accompanying drawings, which are included as part of the detailed description to aid understanding of the present disclosure, provide embodiments of the present disclosure, and together with the detailed description, explain technical features of the present disclosure.

FIG. 1A, FIG. 1B and FIG. 2 are diagrams for describing the configuration and operating waveforms for adjusting the resonance frequency.

FIG. 3 illustrates the structure of a full-wave rectification circuit including a configuration for adjusting the resonant frequency in a parallel resonant receiver, according to an embodiment of the present disclosure.

FIG. 4A and FIG. 4B are diagrams for describing the current flow and operating waveform of a full-wave rectifier according to an embodiment of the present disclosure.

FIG. 5A and FIG. 5B are diagrams for describing the current flow and operating waveform of a half-wave rectifier according to an embodiment of the present disclosure.

FIG. 6 is a flowchart for describing a method of controlling a wireless charging reception system capable of adjusting the resonance frequency, according to an embodiment of the present disclosure.

FIG. 7 is a diagram for describing a method of detecting the phase of a transmission current according to an embodiment of the present disclosure.

FIG. 8 is a block diagram illustrating the configuration of a wireless charging reception device according to an embodiment of the present disclosure.

### DETAILED DESCRIPTION

Since the present disclosure can make various changes and have various embodiments, specific embodiments are illustrated in the drawings and described in detail in the detailed description. However, this is not intended to limit the present disclosure to specific embodiments, and should be understood to include all modifications, equivalents, and substitutes included in the idea and scope of the present disclosure. Similar reference numbers in the drawings indicate the same or similar function throughout the various aspects. The shapes and sizes of elements in the drawings may be exaggerated for clarity. Detailed description of exemplary embodiments to be described later refers to the accompanying drawings, which illustrate specific embodiments by way of example. These embodiments are described in sufficient detail to enable those skilled in the art to practice the embodiments. It should be understood that the various embodiments are different, but need not be mutually exclusive. For example, specific shapes, structures, and characteristics described herein may be implemented in another embodiment without departing from the idea and scope of the present disclosure in connection with one embodiment. Additionally, it should be understood that the location or arrangement of individual components within each disclosed embodiment may be changed without departing from the spirit and scope of the embodiment. Accordingly, the detailed description set forth below is not to be taken in a limiting sense, and the scope of the exemplary embodiments, if properly described, is limited only by the appended claims, along with all equivalents as claimed by those claims.

In the present disclosure, terms such as first and second may be used to describe various components, but the components should not be limited by the terms. These terms are only used for the purpose of distinguishing one component from another. For example, a first element may be termed a second element, and similarly, a second element may be termed a first element, without departing from the scope of the present disclosure. The term and/or includes a combination of a plurality of related recited items or any one of a plurality of related recited items.

When an element of the present disclosure is referred to as being “connected” or “connected” to another element, it may be directly connected or connected to the other element, but it should be understood that other components may exist in the middle. On the other hand, when an element is referred to as “directly connected” or “directly connected” to another element, it should be understood that no other element exists in the middle.

Components appearing in the embodiments of the present disclosure are shown independently to represent different characteristic functions, and do not mean that each component is composed of separate hardware or a single software component. That is, each component is listed and included as each component for convenience of description, and at least two components of each component are combined to form one component, or one component can be divided into a plurality of components to perform functions. An integrated embodiment and a separate embodiment of each of these components are also included in the scope of the present disclosure unless departing from the essence of the present disclosure.

Terms used in the present disclosure are only used to describe specific embodiments, and are not intended to limit the present disclosure. Singular expressions include plural expressions unless the context clearly dictates otherwise. In the present disclosure, terms such as “comprise” or “have” are intended to designate that there are features, numbers, steps, operations, components, parts, or combinations thereof described in the specification, and it should be understood that this does not preclude the possibility of the presence or addition of one or more other features, numbers, steps, operations, components, parts, or combinations thereof. That is, the description of “including” a specific configuration in the present disclosure does not exclude configurations other than the corresponding configuration, and means that additional configurations may be included in the practice of the present disclosure or the scope of the technical spirit of the present disclosure.

Some of the components of the present disclosure may be optional components for improving performance rather than essential components that perform essential functions in the present disclosure. The present disclosure may be implemented including only components essential to implement the essence of the present disclosure, excluding components used for performance improvement, and a structure including only essential components excluding optional components used only for performance improvement is also included in the scope of the present disclosure.

Hereinafter, embodiments of the present disclosure will be described in detail with reference to the drawings. In describing the embodiments of this specification, if it is determined that a detailed description of a related known configuration or function may obscure the gist of the present specification, the detailed description will be omitted. The same reference numerals are used for the same components in the drawings, and redundant descriptions of the same components are omitted.

The system and/or method/device (hereinafter simply referred to as ‘system’) proposed in the present disclosure relates to a wireless charging technology capable of adjusting the resonance frequency in a parallel resonance receiver.

The present disclosure is not a method of adjusting the resonant frequency by adjusting the phase by connecting a switch in parallel to a capacitor to set the basic resonant frequency, but relates to a device and system for adjusting the resonant frequency by adjusting the phase of a rectifier.

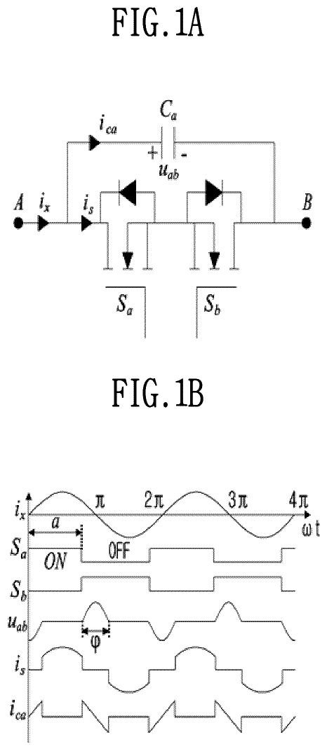

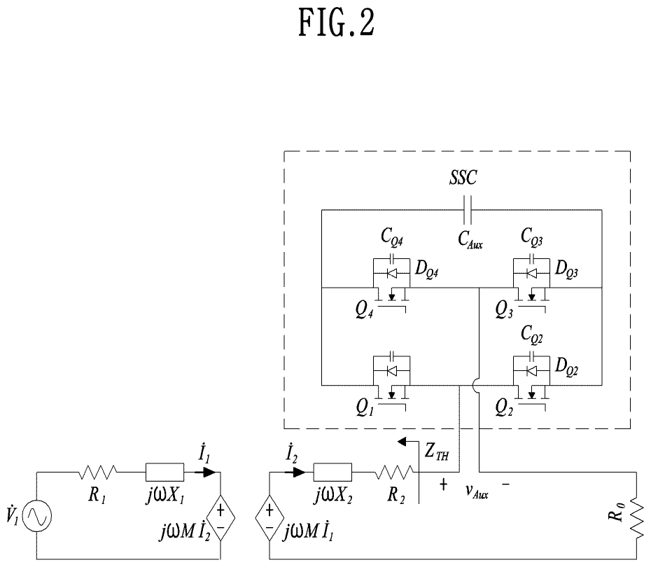

As shown in FIG. 1A and FIG. 1B, by connecting two MOSFET switches (Sₐ, S_{b}) in parallel to control the resonance frequency to the capacitor Ca for basic resonance, and adjusting the switch Sₐ phase, the overall capacitor value can be adjusted, which allows the resonant frequency to be adjusted.

When the circuit is configured according to FIG. 1A and FIG. 1B, there is a problem that a separate switch must be provided to adjust the resonance frequency by adjusting the overall capacitance value, and separate calculation and control are required to control the switch.

As another example, as shown in FIG. 2, a total of four switches (Q1 to Q4) are connected in parallel to the capacitor for setting the basic resonance frequency, and the overall capacitance value may be adjusted by adjusting the phase of each switch. Through this, the resonance frequency can be adjusted.

When the circuit is configured according to FIG. 2, precision can be improved by using a total of four switches, but there is a problem that the complexity of implementing and configuring the circuit further increases.

Hereinafter, a detailed description will be given of a method of adjusting the resonance frequency in a parallel resonance receiver without a separate switch device.

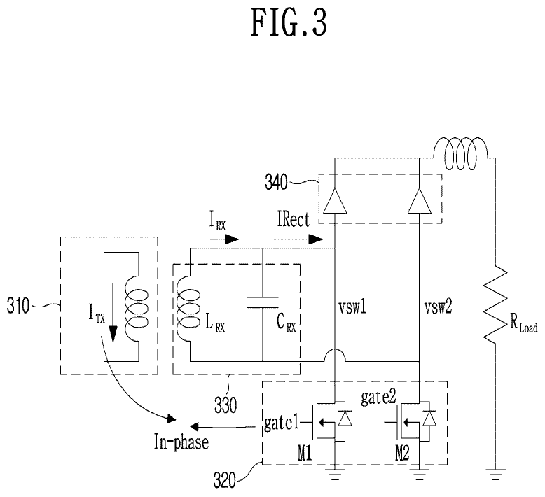

FIG. 3 illustrates the structure of a full-wave rectification circuit including a configuration for adjusting the resonant frequency in a parallel resonant receiver, according to an embodiment of the present disclosure.

As shown in FIG. 3, to adjust the resonance frequency to obtain maximum efficiency in a full-wave rectifier circuit, the gate phases of the two switches (M1 and M2) (i.e., the phases of gate 1 and gate 2 for driving each switch) and the transmission signal (I_{TX}) can be matched.

That is, if the phase of the gate for driving the two switches and the phase of the transmission signal are the same, the resonant frequency of the entire receiver can be kept the same as the frequency of the transmitted signal.

Here, the transmission signal may be generated by the transmission circuit unit 310. For example, the circuit constituting the transmission circuit unit 310 (included in the wireless charging rosin device) may be powered by the power supply voltage unit. The transmission circuit unit 310 may allow a transmission signal (or current) to flow on a transmission antenna (i.e., an equivalent coil (or inductor) corresponding to the transmission antenna shown in FIG. 3) by the supplied power.

When the phase of the receiver switch (i.e., at least one switch included in the switch unit 320) matches the phase of the transmission signal, the resonance frequency of the receiver matches the frequency of the transmission signal. Accordingly, the resonance frequency of the receiver can always be matched to the frequency of the transmission signal without a separate device or control for adjusting the resonance frequency, so that maximum charging efficiency can be achieved.

Specifically, when the power supply frequency is lower than the resonance frequency of the inductor (L_{RX}) and capacitor (C_{RX}) (constituting the resonance circuit unit 330), a section (or interval) may occur where the waveform of IRect momentarily increases. This is because the L_{RX}−C_{RX} time constant is short and the vsw voltage changes quickly. Here, the switch unit 320, the resonance circuit unit 330, and the rectifier circuit unit 340 may be connected in parallel.

Whenever the Vsw voltage converges to 0, I_{RX} can flow to the switch, and the corresponding section (or interval) can have a faster phase than the vsw1 voltage. Accordingly, the rectifier input impedance value may be viewed as a capacitance value and additional capacitance may be viewed as connected to the rectifier circuit, thereby increasing the insufficient capacitance value.

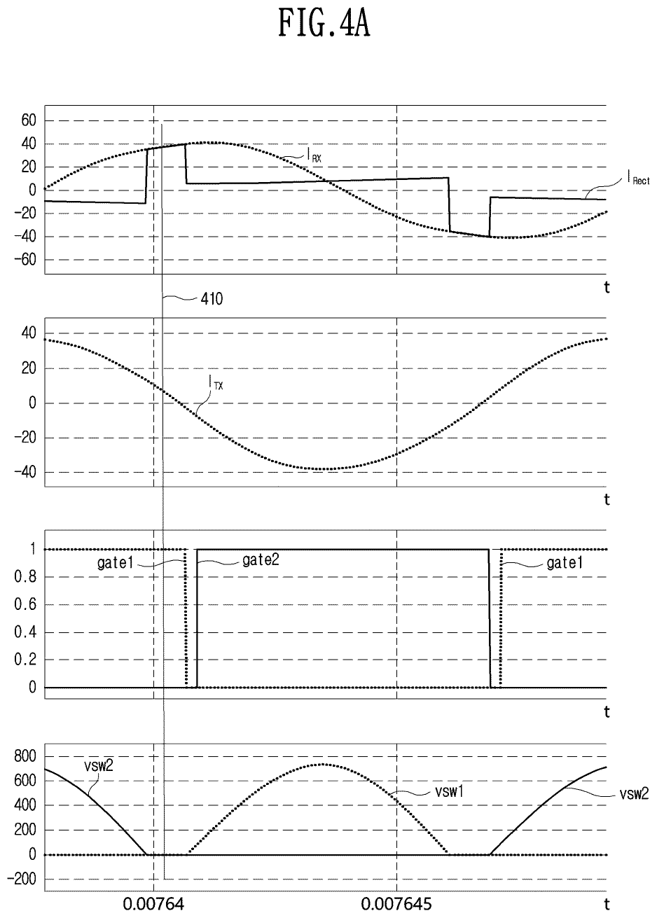

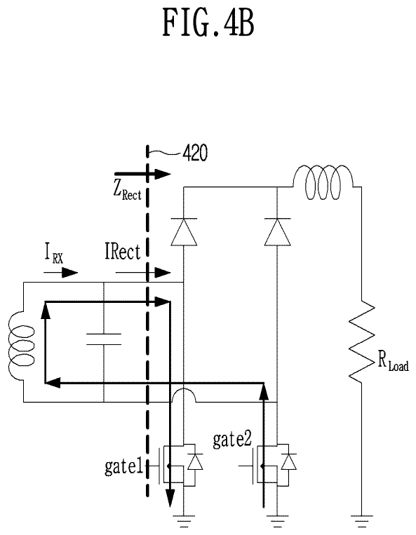

FIG. 4A and FIG. 4B are diagrams for describing the operating waveform of a full-wave rectifier according to an embodiment of the present disclosure.

The current flow at a specific point (e.g., 7.64 msec point) 410 of the waveform shown in FIG. 4A may be formed as shown in FIG. 4B. At a certain point in time, all of the coil current (IRX) can instantaneously flow into the I_{Rect}. Here, I_{Rect} may have a peak point of 40 A. Therefore, the phase of I_{Rect} can be faster than the vsw1 phase.

Therefore, when referring to FIG. 4B, the impedance Z_{Rect} value looking at the rectifier at a specific point 420 may have a capacitor value. For example, if the difference between the transmitter feeding frequency and the LRX−CRX resonance frequency increases, the section (or interval) corresponding to the specific point 410 in FIG. 4A may be longer, and the capacitance value of Z_{Rect} will become larger. Accordingly, the resonant frequency of the full-wave rectifier can be automatically maintained without separate control.

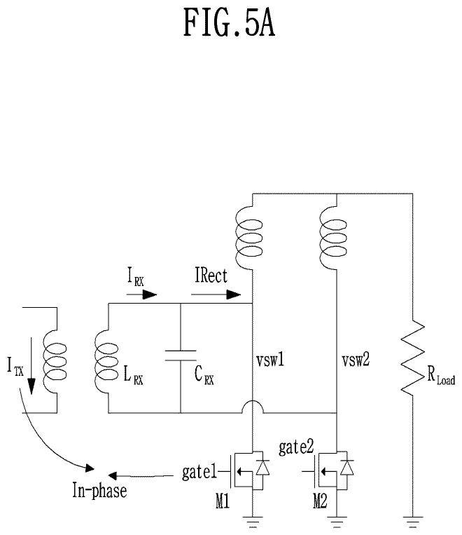

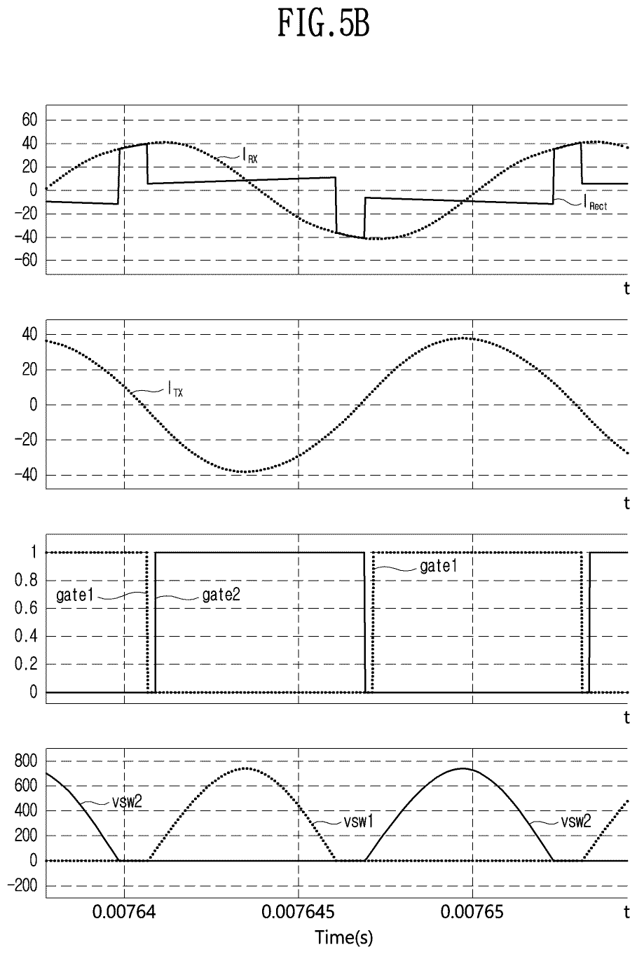

FIG. 5A and FIG. 5B are diagrams for describing the structure and operating waveform of a half-wave rectifier with a built-in resonance frequency adjustment function according to an embodiment of the present disclosure.

As shown in FIG. 5A, when matching the phase of the gate signals (gate 1 and gate 2) for driving the two built-in switches (M1 and M2) in the half-wave rectifier with the phase of the transmission signal (I_{TX}), the resonant frequency is automatically adjusted so that maximum efficiency can be obtained.

FIG. 5B shows the current and voltage waveforms output from each component of the circuit implemented as shown in FIG. 5A.

As mentioned above, by controlling the phase of the receiver switch according to the present disclosure in real time without applying an additional tuning capacitor or an additional switch, the resonant frequency of the receiver can be automatically controlled even in changing transmission environments. Accordingly, maximum efficiency can be maintained in a wireless charging environment.

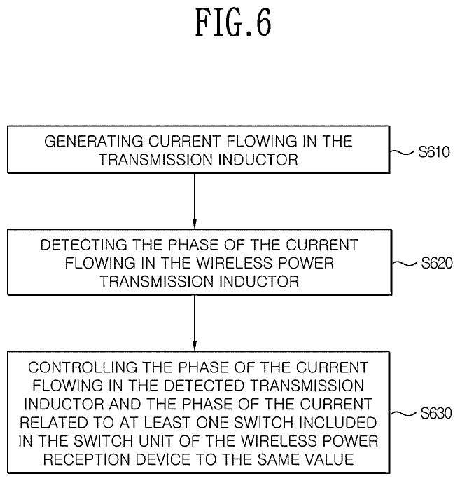

FIG. 6 is a flowchart for describing a method of controlling a wireless charging reception system capable of adjusting the resonance frequency, according to an embodiment of the present disclosure.

The wireless charging system may include a wireless power transmission device and a wireless power receiving device that supplies power wirelessly. FIG. 6 is a flowchart for describing a control method of a wireless power transmission device and a wireless power reception device.

The wireless power transmission device may generate current flowing in the transmission inductor by driving the power voltage unit included in the transmission circuit unit (S610). Here, the transmission inductor may refer to the equivalent inductor of a transmission antenna for supplying wireless power.

The wireless power transmission device and/or the wireless power reception device may detect the phase of the current flowing in the wireless power transmission inductor (S620).

The wireless power reception device may control the phase of the current flowing in the detected transmission inductor and the phase of the current related to at least one switch included in the switch unit of the wireless power reception device to the same value (S630).

Specifically, the wireless power reception device may include a resonance circuit unit including a circuit in which a resonance inductor and a resonance capacitor are connected in parallel, a switch unit connected in parallel with the resonance circuit unit and including at least one switch, a rectifier circuit connected in parallel with the switch unit resonance circuit unit and a control unit.

Based on the transmitting inductor of the wireless power transmission device being adjacent to the resonant inductor of the wireless power reception device within a critical distance, the wireless power reception device may control the phase of the transmission current flowing in the transmission inductor and the phase of the current related to at least one switch to be the same value through the control unit.

Specifically, the control unit may include a detection circuit for detecting the phase of the transmission current and a control circuit for controlling the phase of the current flowing through the gate of at least one switch. However, this is only an example, and a detection circuit that detects the phase of the transmission current may be included in the wireless power transmission device.

Based on the phase of the transmission current being detected through the detection circuit (or based on the phase of the transmission current being received from the wireless power transmission device), the controller may control the control circuit so that the phase of the detected transmission current and the phase of the gate current of at least one switch are the same value.

Here, the current related to at least one switch may include a current flowing in the gate of at least one switch for driving the at least one switch. The rectifier circuit unit may include at least one diode or at least one inductor connected in parallel to each of the resonance circuit unit and the switch unit. In addition, the rectifier circuit may be connected in series with at least one of a load or an additional inductor to which the output voltage will be applied.

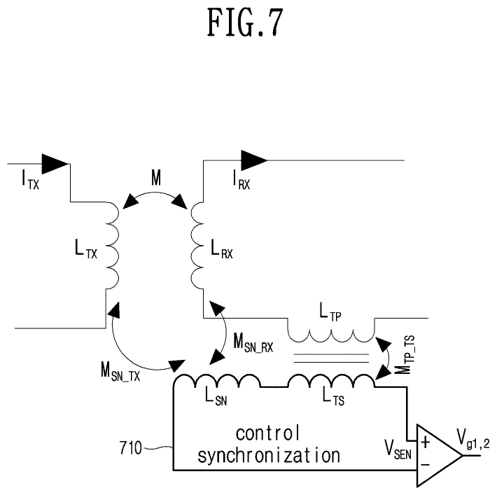

FIG. 7 is a diagram for describing a method of detecting the phase of a transmission current according to an embodiment of the present disclosure.

The wireless charging reception device may include a detection circuit 710 for detecting the phase of the transmission current (I_{TX}) flowing in the transmission inductor (L_{TX}). The detection circuit 710 may include a sensing inductor (L_{SN}) and a transformer to detect the phase of the transmission current. One of the two inductors (i.e., L_{TP} and L_{TS}) constituting the transformer (i.e., L_{TP}) may be connected in series with the resonance inductor (L_{RX}) in the resonance circuit part.

Specifically, the coupling between the sensing inductor (L_{SN}) and the resonant inductor (L_{RX}) can be canceled through a transformer. That is, the mutual inductance value (M_{SN_RX}) between the sensing inductor (L_{SN}) and the resonance inductor and the mutual inductance value of the transformer (i.e., mutual inductance value between L_{TP} and L_{TS}) (M_{TP_TS}) can be controlled to be the same value.

The voltage (V_{SEN}) induced by the sensing inductor (L_{SN}) may be derived as shown in Equation 1.

$${V}_{SEN} = j ω {M}_{SN \_ TX} {I}_{TX} + j ω {M}_{SN \_ RX} {I}_{RX} - j ω {M}_{TP \_ TS} {I}_{RX} \qquad [ Equation 1 ]$$

In equation 1, as the mutual inductance value (M_{SN_RX}) between the sensing inductor (L_{SN}) and the resonant inductor and the mutual inductance value of the transformer (i.e., mutual inductance value between and L_{TP} and L_{TS}) (M_{TP_TS}) are controlled/designed to be the same value, V_{SEN} may include only the I_{TX} phase. The wireless charging reception (or control unit) may detect the relevant phase through V_{SEN}.

However, this is only an example, and the wireless charging reception device may detect the phase of the transmission current through a separate detection device.

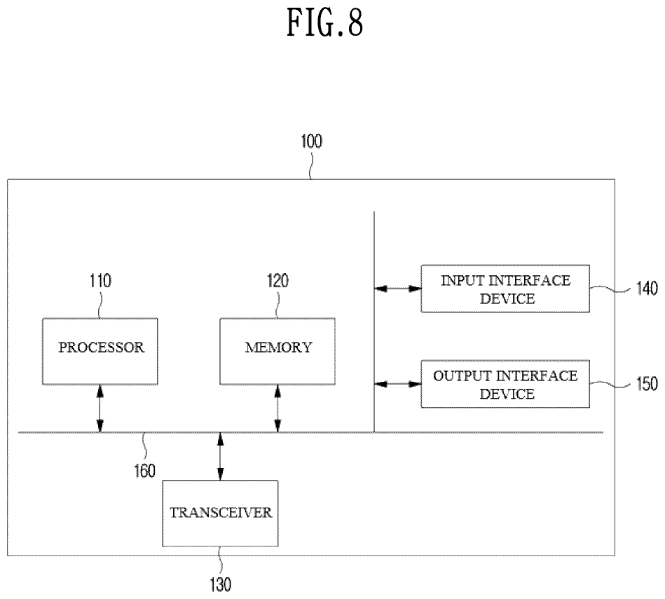

FIG. 8 is a block diagram illustrating the configuration of a wireless charging reception device according to an embodiment of the present disclosure.

The wireless power reception device 100 refers to a device that wirelessly provides/receives power from a wireless power transmission device. A wireless power transmission device can be implemented as various types of devices that receive power wirelessly.

The wireless power reception device 100 may include at least one of a processor 110, a memory 120, a transceiver 130, an input interface device 140, and an output interface device 150. Each component is connected by a common bus 160 and can communicate with each other. Additionally, each component may be connected through an individual interface or individual bus centered on the processor 110, rather than through the common bus 160.

The processor 110 may be implemented in various types such as an application processor (AP), central processing unit (CPU), graphics processing unit (GPU), etc., and may be any semiconductor device that executes instructions stored in the memory 120. The processor 110 may execute program commands stored in the memory 120. The processor 110 may be driven to perform the operations of the control unit described in FIG. 6 above. That is, the control unit in FIG. 6 may be implemented as a component of the processor 110 of the device 100.

And/or, the processor 110 may store a program command for implementing at least one function for one or more modules in the memory 120 and control the operation described based on FIG. 6 to be performed. That is, each operation and/or function according to FIG. 6 may be executed by one or more processors 110.

Memory 120 may include various types of volatile or non-volatile storage media. For example, the memory 120 may include read-only memory (ROM) and random access memory (RAM). In an embodiment of the present disclosure, the memory 120 may be located inside or outside the processor 110, and the memory 120 may be connected to the processor 110 through various known means.

The transmitting and receiving unit 130 may perform a function of transmitting and receiving data processed/to be processed by the processor 110 with an external device and/or an external system.

For example, the transceiver 130 may be used to exchange data with other terminal devices (for example, the phase of a transmission signal of a wireless power transmission device, etc.).

The input interface device 140 is configured to provide data to the processor 110.

The output interface device 150 is configured to output data from the processor 110.

Components described in the exemplary embodiments of the present disclosure may be implemented by hardware elements. For example, The hardware element may include at least one of a digital signal processor (DSP), a processor, a controller, an application specific integrated circuit (ASIC), a programmable logic element such as an FPGA, a GPU, other electronic devices, or a combination thereof. At least some of the functions or processes described in the exemplary embodiments of the present disclosure may be implemented as software, and the software may be recorded on a recording medium. Components, functions, and processes described in the exemplary embodiments may be implemented as a combination of hardware and software.

The method according to an embodiment of the present disclosure may be implemented as a program that can be executed by a computer, and the computer program may be recorded in various recording media such as magnetic storage media, optical reading media, and digital storage media.

Various techniques described in this disclosure may be implemented as digital electronic circuits or computer hardware, firmware, software, or combinations thereof. The above techniques may be implemented as a computer program product, that is, a computer program or computer program tangibly embodied in an information medium (e.g., machine-readable storage devices (e.g., computer-readable media) or data processing devices), a computer program implemented as a signal processed by a data processing device or propagated to operate a data processing device (e.g., a programmable processor, computer or multiple computers).

Computer program(s) may be written in any form of programming language, including compiled or interpreted languages. It may be distributed in any form, including stand-alone programs or modules, components, subroutines, or other units suitable for use in a computing environment. A computer program may be executed by a single computer or by a plurality of computers distributed at one or several sites and interconnected by a communication network.

Examples of information medium suitable for embodying computer program instructions and data may include semiconductor memory devices (e.g., magnetic media such as hard disks, floppy disks, and magnetic tapes), optical media such as compact disk read-only memory (CD-ROM), digital video disks (DVD), etc., magneto-optical media such as floptical disks, and ROM (Read Only Memory), RAM (Random Access Memory), flash memory, EPROM (Erasable Programmable ROM), EEPROM (Electrically Erasable Programmable ROM) and other known computer readable media. The processor and memory may be complemented or integrated by special purpose logic circuitry.

A processor may execute an operating system (OS) and one or more software applications running on the OS. The processor device may also access, store, manipulate, process and generate data in response to software execution. For simplicity, the processor device is described in the singular number, but those skilled in the art may understand that the processor device may include a plurality of processing elements and/or various types of processing elements. For example, a processor device may include a plurality of processors or a processor and a controller. Also, different processing structures may be configured, such as parallel processors. In addition, a computer-readable medium means any medium that can be accessed by a computer, and may include both a computer storage medium and a transmission medium.

Although this disclosure includes detailed descriptions of various detailed implementation examples, it should be understood that the details describe features of specific exemplary embodiments, and are not intended to limit the scope of the invention or claims proposed in this disclosure.

Features individually described in exemplary embodiments in this disclosure may be implemented by a single exemplary embodiment. Conversely, various features that are described for a single exemplary embodiment in this disclosure may also be implemented by a combination or appropriate sub-combination of multiple exemplary embodiments. Further, in this disclosure, the features may operate in particular combinations, and may be described as if initially the combination were claimed. In some cases, one or more features may be excluded from a claimed combination, or a claimed combination may be modified in a sub-combination or modification of a sub-combination.

Similarly, although operations are described in a particular order in a drawing, it should not be understood that it is necessary to perform the operations in a particular order or order, or that all operations are required to be performed in order to obtain a desired result. Multitasking and parallel processing can be useful in certain cases. In addition, it should not be understood that various device components must be separated in all exemplary embodiments of the embodiments, and the above-described program components and devices may be packaged into a single software product or multiple software products.

Exemplary embodiments disclosed herein are illustrative only and are not intended to limit the scope of the disclosure. Those skilled in the art will recognize that various modifications may be made to the exemplary embodiments without departing from the spirit and scope of the claims and their equivalents.

Accordingly, it is intended that the present disclosure include all other substitutions, modifications and variations falling within the scope of the following claims.

What is claimed is:

1. A wireless charging reception system with adjustable resonance frequency, the system comprising:
a resonance circuit unit including a circuit in which a resonance inductor and a resonance capacitor are connected in parallel;
a transmission circuit unit including a transmission inductor and a power supply voltage unit adjacent to the resonance inductor within a threshold distance;
a switch unit connected in parallel with the resonance circuit unit and including at least one switch;
a rectifier circuit connected in parallel with the switch unit and the resonance circuit unit; and
a control unit that controls a phase of transmission current flowing through the transmission inductor generated through the power voltage unit to be same as a phase of current associated with the at least one switch.

2. The system of claim 1, wherein:
the current associated with the at least one switch includes current flowing in a gate of the at least one switch for driving the at least one switch.

3. The system of claim 1, wherein:
the rectifier circuit unit includes at least one diode or at least one inductor connected in parallel to each of the resonance circuit unit and the switch unit.

4. The system of claim 2, wherein:
the control unit includes a detection circuit for detecting the phase of the transmission current and a control circuit for controlling the phase of the current flowing through the gate of the at least one switch, and
the rectifier circuit is connected in series with at least one of a load to which an output voltage is to be applied or an additional inductor.

5. The system of claim 4, wherein:
based on the phase of the transmission current being detected through the detection circuit, the control unit controls the control circuit so that a phase of the detected transmission current and the phase of the current of the gate of the at least one switch are a same value.

6. The system of claim 4, wherein:
the detection circuit includes a sensing inductor and a transformer for detecting the phase of the transmission current, and
one of two inductors constituting the transformer is connected in series with the resonance inductor in the resonance circuit unit.

7. The system of claim 6, wherein:
the control unit controls a mutual inductance value between the sensing inductor and the resonance inductor so that a mutual inductance value of the transformer is a same value.

8. A method of controlling a wireless charging reception system with adjustable resonance frequency, the method comprising:
generating a current flowing in a transmission inductor by driving a power supply voltage unit included in a transmission circuit unit;
detecting a phase of current flowing in the transmission inductor; and
controlling a phase of the detected current flowing in the transmission inductor and a phase of current associated with at least one switch included in a switch unit to a same value,
wherein the switch unit is connected in parallel with a resonance circuit unit including a resonance inductor and a resonance capacitor adjacent to the transmission inductor within a critical distance, and
wherein a current circuit unit is connected in parallel to the switch unit and the resonance circuit unit.

9. The method of claim 8, wherein:
the current associated with the at least one switch includes current flowing in a gate of the at least one switch for driving the at least one switch.

10. The method of claim 8, wherein:
a rectifier circuit unit includes at least one diode or at least one inductor connected in parallel to each of the resonance circuit unit and the switch unit.

11. The method of claim 9, wherein:
the system includes a detection circuit for detecting the phase of the transmission current and a control circuit for controlling the phase of the current flowing in the gate of the at least one switch, and
the rectifier circuit is connected in series with at least one of a load to which an output voltage is to be applied or an additional inductor.

12. The method of claim 11, wherein:
the detection circuit includes a sensing inductor and a transformer for detecting the phase of the transmission current, and
one of two inductors constituting the transformer is connected in series with the resonance inductor in the resonance circuit unit.

13. The method of claim 12, wherein:
a mutual inductance value between the sensing inductor and the resonance inductor and a mutual inductance value of the transformer are controlled to be a same value.

14. A wireless charging reception device capable of adjusting a resonance frequency, the wireless charging reception device comprising:
a resonance circuit unit including a circuit in which a resonance inductor and a resonance capacitor are connected in parallel;
a switch unit connected in parallel with the resonance circuit unit and including at least one switch;
a rectifier circuit connected in parallel with the switch unit and the resonance circuit unit; and
a control unit that controls a phase of transmission current flowing in a transmission inductor and a phase of current associated with the at least one switch to be a same value, based on the transmission inductor of a wireless power transmission device being adjacent to the resonance inductor by a threshold distance.

15. The wireless charging reception device of claim 14, wherein:
the control unit is configured to:
based on the phase of the transmission current being detected through the detection circuit, control the control circuit so that the phase of the detected transmission current and the phase of the current of the gate of the at least one switch are a same value.

16. The wireless charging reception device of claim 15, wherein:
the detection circuit includes a sensing inductor and a transformer for detecting the phase of the transmission current, and
one of two inductors constituting the transformer is connected in series with the resonance inductor in the resonance circuit unit.

17. The wireless charging reception device of claim 16, wherein:
the control unit is configured to:
control a mutual inductance value between the sensing inductor and the resonance inductor so that the mutual inductance value of the transformer is a same value.
